(19) United States
(12) Patent Application Publication
(10) Pub. No.: US 2009/0254736 A1
(43) Pub. Date: Oct. 8, 2009

(54) Data processing system for performing data rearrangement operations

(75) Inventors: Dominic Hugo Symes, Cambridge (GB); Mladen Wilder, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 12/078,875

(22) Filed: Apr. 7, 2008

(51) Int. Cl. G06F 9/30

(52) U.S. Cl. 712/225; 712/E09.016

(57) ABSTRACT

An apparatus for processing data is provided comprising rearrangement circuitry having a plurality of rearrangement stages for rearranging a plurality N of input data elements, each rearrangement stage comprising at most N multiplexers arranged to select between M data elements where M is in integer less than N. Control circuitry is provided that is responsive to program instructions to control the rearrangement circuitry to perform rearrangement operations. The rearrangement circuitry is configurable by the control circuitry to perform a plurality of different rearrangement operations. The rearrangement circuitry comprises main rearrangement circuitry having a plurality of rearrangement stages in which there is a unique path between any given input element and any given output element and supplementary rearrangement circuitry in which from each input data element there is a path to at most C output data elements where 1<C<N/2.

### BACKGROUND OF THE INVENTION

1. Field of the Invention

The present invention relates to an apparatus for performing rearrangement operations on data.

Data processing applications such as signal processing applications typically require data rearrangement operations to be performed at a high data rate. When data processing is sufficiently accelerated, for example, when using a single instruction multiple data (SIMD) engine, then data rearrangements can become a bottleneck in performing computations. Furthermore, for wide SIMD machines, the data rearrangement unit required to correctly order the data for performing SIMD operations is typically large and power hungry.

2. Description of the Prior Art

It is known to perform data rearrangement operations using a full cross-bar circuit, which allows any input data element to go to any output element position. However, such cross-bar networks involve the order of N² logic gates for an N-input cross-bar. Accordingly, cross-bar networks are not very area-efficient and become expensive as the SIMD width increases beyond around eight data elements.

It is also known to provide a dedicated circuit for the purpose of performing a given interleave operation or a de-interleave operation, which enables the circuit to be specifically configured to suit the particular type of rearrangement operation being targeted. However, such dedicated circuits are inflexible and a separate circuit would be required for each different rearrangement operation that is to be performed.

It is also known to use a full permutation network to perform a full range of permutations. Such known permutation networks comprise a plurality of so-called “butterfly networks” in parallel or in series, for example, two butterfly networks arranged back-to-back. Such an arrangement is described in the publication “Fast Subword Permutation Instructions Based on Butterfly Networks” by X. Yang, M. Vachharajani and R. B. Lee, Proceedings of SPIE, Media Processor 2000 Jan. 27-28, 2000 San Jose Calif., pages 80-86. However, such circuitry comprising a plurality of butterfly networks is large and power hungry due to the large number of multiplexers required to implement the full set of permutations.

Thus there is a requirement to provide a smaller and more efficient rearrangement circuit that is flexible enough to be able to perform a plurality of different frequently performed data rearrangements.

### SUMMARY OF THE INVENTION

According to a first aspect, the present invention provides apparatus for processing data comprising:

rearrangement circuitry having a plurality of rearrangement stages for rearranging a plurality N of input data elements, each rearrangement stage comprising at most N multiplexers arranged to select between M data elements, where M is an integer less than N;

control circuitry responsive to program instructions to control said rearrangement circuitry to perform rearrangement operations;

wherein said rearrangement circuitry comprises main rearrangement circuitry having a plurality of rearrangement stages in which there is a unique path between any given input element and any given output element and supplementary rearrangement circuitry in which from each input data element there is a path to at most C output data elements where 1<C<N/2, and wherein said rearrangement circuitry is configurable by said control circuitry to perform a plurality of different rearrangement operations.

The present invention recognises that a full permutation network is not necessary in order to provide a plurality of different data rearrangement operations that are common in data processing systems such as SIMD machines. Instead of providing a full permutation network, the present invention provides rearrangement circuitry comprising main rearrangement circuitry having a first number of rearrangement stages in which there is a unique path between any given input element and any given output element and also a supplementary rearrangement circuitry in which from each input data element there is a path to at most C output data elements where 1<C<N/2. The rearrangement circuitry is configurable by control circuitry to perform a plurality of different rearrangement operations. Thus the circuit according to the present invention is typically more area efficient and less power hungry than previously known rearrangement circuits such as back-to-back butterfly networks and full cross-bar circuits, yet it has the flexibility to perform more than one type of rearrangement operation. The present invention recognises that a plurality of rearrangement operations (less than a full set of permutation operations) can be implemented in a circuit that is different from and typically more area-efficient and less power-hungry than full a permutation circuit or a plurality of individual circuits, each specifically designed for particular permutation operation, yet still provides the flexibility to perform frequently-occurring permutation operations.

It will be appreciated that the number of output data elements to which the supplementary rearrangement circuitry provides a path from each data element could be any number C in the range 1<C<N/2, where N is the number of data elements rearranged by the rearrangement circuitry. However, in one embodiment, C=2. This provides a flexible implementation of the supplementary rearrangement circuitry that is inexpensive to implement.

It will be appreciated that the number of data elements N rearranged by the rearrangement circuitry could be any number. However, in one embodiment, N≧8. In this case the rearrangement circuitry is more area efficient and less power hungry than e.g. back to back butterfly networks since, for example, it requires fewer multiplexers in total.

It will be appreciated that the supplementary rearrangement circuit could comprise any number of rearrangement stages provided that from each input data element there is a path to at most C output data elements where 1<C<N/2. However, in one embodiment the supplementary rearrangement circuitry comprises a single rearrangement stage. This provides enough flexibility to perform a plurality of different rearrangement operations yet reduces the total number of cross points required in the rearrangement circuitry thus making circuitry more area-efficient.

It will be appreciated that the supplementary rearrangement circuitry could be arranged to perform any one of a number of different rearrangement operations in which data elements are optionally permuted. However in one embodiment, the supplementary rearrangement circuitry is arranged to perform an optional reversal operation. This is straightforward to implement, yet provides flexibility to increase the number of possible different output data orderings than could be performed by the main rearrangement circuitry alone.

In one such embodiment in which the supplementary rearrangement circuitry is arranged to perform an optional reversal operation, the supplementary rearrangement circuitry is configured to receive a plurality P of input data elements and to optionally exchange an input data element i with an input data element P−1-i, where i is an integer in the range 0 to (P−1) and where P is equal to N.

It will be appreciated that in embodiments in which the supplementary rearrangement circuit is arranged to perform an optional reversal operation, the reversal operation could be performed on only a subset of the plurality N of input data elements received by the supplementary rearrangement circuitry. However, in one embodiment the reversal operation is performed on the full set of N data elements received by the supplementary rearrangement circuitry. This provides greater flexibility to reverse the position of any pair data elements of the full set.

It will be appreciated that the main rearrangement circuitry could comprise any rearrangement circuitry in which there is a unique path between a given input element and a given output element. However, in one embodiment, the main rearrangement circuit comprises a butterfly network. Butterfly networks are simple to configure and efficient to implement.

It will be appreciated that the multiplexers of the arrangement circuitry could be any one of a number of different types of multiplexer having different numbers of inputs and/or outputs. However, in one embodiment M=2, such that each of the multiplexers of the rearrangement circuitry is arranged to select between two data elements. This makes the rearrangement circuitry straightforward to implement and is less complex than having multiplexers arranged to select between more than two data elements.

In one embodiment, the supplementary rearrangement circuitry is arranged to perform the supplementary rearrangements prior to (i.e. temporally preceding) the main rearrangement circuitry performing the main rearrangements. However, in another embodiment the supplementary rearrangement circuitry is arranged to perform the supplementary rearrangements after the known rearrangement circuitry has performed the main rearrangements. Thus the order in which data is supplied to the main rearrangement circuitry and the supplementary rearrangement circuitry can be appropriately selected as required for the given processing task.

It will be appreciated that the rearrangement circuitry could comprise one of a range of different numbers of multiplexers yet would still be more efficient than the known full permutation networks or full cross-bar circuits provided that the number of multiplexers is less than required in these known circuits. However, in one embodiment, the rearrangement circuitry comprises a total of (log₂ (N)+1)*N multiplexers. This compares favourably with the known full cross-bar circuit that requires N*(N−1) multiplexers and also for a full permutation network that requires (2*log₂ (N)−1)*N multiplexers.

It will be appreciated that the main rearrangement circuitry could comprise any one of a range of different rearrangement stages as required to provide a plurality of different rearrangement operations. However in one embodiment the main rearrangement circuitry comprises the total of log₂ N stages.

It will be appreciated that the N input data elements to the rearrangement circuitry could be single-bit data elements. However, in one embodiment, at least one of the N input data elements in a multi-bit data element. This provides the capability to process more complex input vectors as may be required in for example, SIMD machines.

In one embodiment the data processing apparatus comprises a register bank and each of the plurality N of input data elements is read from the register bank. Storage of the input data elements in a register bank mean that they can be efficiently retrieved as required by the processing apparatus without having to read them from external data storage. In one such embodiment comprising a register bank, each register of the register bank is arranged to store a packed vector comprising a plurality of multi-bit data elements, each of the multi-bit data elements corresponding to a respective one of a plurality N of input data elements of the rearrangement circuitry. The use of packed input vectors makes the rearrangement calculation more efficient by facilitating parallelisation of the rearrangement operations.

It will be appreciated that the plurality N of input data elements supplied as input to the rearrangement circuitry could be supplied from a single register of the register bank. However, in one embodiment, the plurality N of input data elements of the rearrangement circuitry are read from a plurality Q of registers of the register bank. Thus, for example a single input vector to the rearrangement circuitry could be formed from the contents of two or more registers of the register bank.

In one embodiment the control circuitry is responsive to a rotation program instruction to cause the rearrangement circuitry to perform a rotation operation on the plurality of N input data elements.

In another embodiment the control circuitry is responsive to an interleave program instruction to cause the rearrangement circuitry to perform an interleave operation on two vectors of length N/2.

In another embodiment the control circuitry is responsive to a de-interleave program instruction to cause the rearrangement circuitry to perform a de-interleave operation on two vectors of length N/2.

It will be appreciated that the plurality of different rearrangement operations that can be performed by the rearrangement circuitry could take on a number of different forms. However in one embodiment, the rearrangement circuitry is configurable to perform each of a rotation operation, an interleave operation and a de-interleave operation. This provides the flexibility to perform three different types of frequently occurring rearrangement operations implemented in rearrangement circuitry that is more area-efficient and less power hungry that known full permutation circuits.

Although the rearrangement operation can be performed by rearranging individual ones of the plurality N of input data elements relative to others individual ones of the plurality of input data elements, in one embodiment control circuitry is arranged to control the rearrangement circuitry to perform one or more of the rearrangement operations such that groups of two or more of the plurality N of input data elements are rearranged.

According to a second aspect, the present invention provides a method of performing rearrangement operations on data on a data processing apparatus having rearrangement circuitry consisting of main rearrangement circuitry and supplementary rearrangement circuitry, said rearrangement circuitry having a plurality of rearrangement stages for rearranging a plurality N of input data elements, each rearrangement stage comprising at most N multiplexers arranged to select between M data elements, where M is an integer less than N and having control circuitry responsive to program instructions to control said rearrangement circuitry to perform rearrangement operations, said method comprising:

using said main rearrangement circuitry having a plurality of rearrangement stages in which there is a unique path between any given input element and any given output element to perform a main set of rearrangement operations on at least a subset of said plurality N of input data elements;

using said supplementary rearrangement circuitry in which from each input data element there is a path to at most C output data elements where 1<C<N/2 to perform a supplementary set of rearrangement operations on at least a subset of said plurality N of input data elements; and

using said control circuitry to configure said main rearrangement circuitry and said supplementary rearrangement circuitry to perform said main set of rearrangement operations and said supplementary set of rearrangement operations respectively.

According to a third aspect, the present invention provides a virtual machine providing an emulation of an apparatus for processing data, said apparatus comprising:

rearrangement circuitry having a plurality of rearrangement stages for rearranging a plurality N of input data elements where N is an integer greater than or equal to two, each rearrangement stage comprising at most N multiplexers arranged to select between M data elements, where M is an integer less than N;

control circuitry responsive to program instructions to control said rearrangement circuitry to perform rearrangement operations;

wherein said rearrangement circuitry comprises a main rearrangement circuitry having a plurality of rearrangement stages in which there is a unique path between any given input element and any given output element and a supplementary rearrangement circuitry in which from each input data element there is a path to at most C output data elements where 1<C<N/2 and wherein said rearrangement circuitry is configurable by said control circuitry to perform a plurality of different rearrangement operations.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing apparatus according to an embodiment of the present invention;

FIG. 2 schematically illustrates the rearrangement circuitry of FIG. 1 in more detail;

FIG. 3A schematically illustrates a configuration of the rearrangement circuitry for performing a rotation of a packed input vector of N=8 input data elements by three positions;

FIG. 3B schematically illustrates how the input vector to the circuit of FIG. 3A is formed from a plurality of multi-bit data elements;

FIG. 4 schematically illustrates an embodiment of the rearrangement circuitry of FIG. 1 configured to perform an interleave rearrangement operation;

FIG. 5 schematically illustrates an embodiment of the rearrangement circuitry of FIG. 1 configured to perform an interleave operation in which the main rearrangement circuitry is arranged to perform a rearrangement prior to the supplementary rearrangement circuitry;

FIG. 6 schematically illustrates an embodiment of the rearrangement circuitry of FIG. 1 configured to perform a de-interleave (unzip) permutation operation in which a single reversal stage is performed prior to a butterfly network permutation; and

FIG. 7 schematically illustrates an embodiment of the rearrangement circuitry of FIG. 1 configured to perform an interleave permutation applied to groups of two data elements.

### DESCRIPTION OF THE PREFERRED EMBODIMENTS

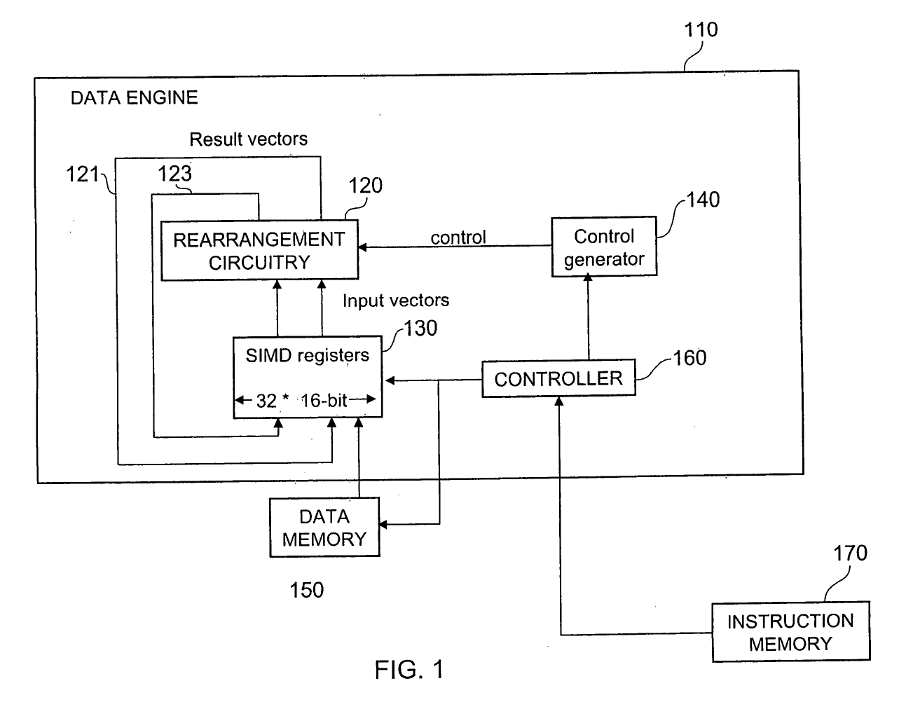

FIG. 1 schematically illustrates a data processing apparatus according to an embodiment of the present invention. The apparatus comprises a data engine 110 having rearrangement circuitry 120, SIMD registers 130 a control generator 140 and a controller 160. The apparatus further comprises, externally to the data engine, a data memory 150, and an instruction memory 170.

The rearrangement circuitry 120 is configured to perform a plurality of different rearrangement operations on packed input vectors which are supplied to the rearrangement circuitry 120 from the SIMD registers 130. Each of the SIMD registers 130 comprises 32 data elements each comprising 16 bits. Such input vectors comprising a plurality of data elements are known as packed vectors. Input vectors for the rearrangement operations performed by the rearrangement circuitry 120 are performed on packed input vectors each comprising 64 data elements read in from pairs of SIMD registers 130. The results of the rearrangement operations are written back into the SIMD register bank 130 via data paths 121 and 123.

The data memory 150, corresponding to which is external to the data engine, is used to store data elements both input data elements on which the rearrangement operations are performed and results of the rearrangement operations. The data engine 110 performs data processing operations in response to execution of program instructions read in from the instruction memory 170. The instruction memory supplies program instructions to the controller 160, which converts those instructions into control signals for controlling the processing circuitry 120, 130, 140 of the data engine. The control signals from the controller 160 are also supplied to the external data memory 150, the SIMD registers 130 of the data engine and the control generator 140 of the data engine.

The control generator 140 of the data engine generates control signals for configuring the rearrangement circuitry 120 to perform a plurality of different rearrangement operations. The particular configuration of the rearrangement circuitry 120 depends upon the instruction that is currently being executed. In this particular embodiment, the rearrangement circuitry 120 is not capable of performing a full range of permutation operations, but can perform at least rotation operations, interleave operations, and de-interleave operations.

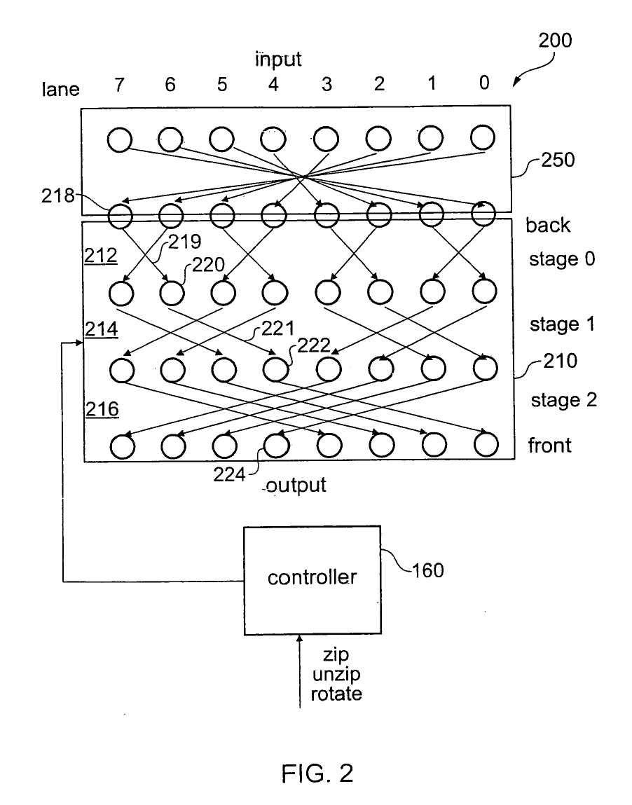

FIG. 2 schematically illustrates the rearrangement circuitry of FIG. 1 in more detail. The rearrangement circuitry of FIG. 2 comprises main rearrangement circuitry 210 and supplementary rearrangement circuitry 250. The rearrangement circuitry 120 is configured to perform a plurality of different rearrangement operations in dependence upon control signals from the controller 160 (see FIG. 1) which are generated in response to program instructions.

The main rearrangement circuitry 210 comprises a butterfly network whilst in this embodiment the rearrangement circuitry 250 comprises a single reversal stage. The rearrangement circuitry of FIG. 2 operates on a plurality N=8 input data elements. This number of input data elements has been chosen for simplicity of illustration, but it will be appreciated that in the rearrangement of FIG. 1 the rearrangement circuitry 120 actually operates on N=64 data elements.

The rearrangement circuitry 200 of FIG. 2 is capable of performing (amongst others) a rotation operation to rotate a vector by k places where 0≦k<N, where k can be selected by the programmer. The rearrangement circuitry 200 can also perform an interleave (zip) permutation operation on two input vectors each having length N/2. Furthermore, the rearrangement circuitry 200 is capable of performing a de-interleave (or unzip) operation on two vectors of length N/2.

In the circuit of FIG. 2 each solid arrow indicates a possible swap path for a given data element from one rearrangement stage to a subsequent rearrangement stage. Note that there are additional pass-through paths (not shown) between data elements in which a data element in one stage does not change position in the succeeding stage. These pass-through paths have been omitted from FIG. 2 for simplicity of illustration.

The supplementary rearrangement circuitry 250 is arranged to optionally exchange input data element 0 with input data element 7; input data element 1 with input data element 6; input data element 2 with input data element 5; and input data element 3 with input data element 4. Accordingly, if the input data elements are indexed from 0 to P, the reversal operation performed by the supplementary rearrangement circuitry optionally exchanges an input data element i with an input data element (P−1-i), where i is an integer in the range 0 to P−1 and where P is equal to N. In this embodiment, the supplementary rearrangement circuitry provides a path to at most 2 output data elements (straight through data path and single exchange data path). The supplementary rearrangement circuitry 350, 450, 550, 650, 750 in FIGS. 2, 3A, 4, 5, 6, 7 respectively described below also provide a path to at most two output data elements. In alternative embodiments, the supplementary rearrangement circuitry is arranged such that from each input data element there is a path to at most C output data elements where 1<C<N/2. Thus the supplementary rearrangement circuitry is not a butterfly network.

The main rearrangement circuitry comprises a first rearrangement stage 212, a second rearrangement stage 214 and a third rearrangement stage 216. In general, a butterfly network comprises a total of log₂ N stages for N input data elements. The total number of cross-points in a butterfly network is N log₂ N. This is fewer than the N² cross-points that would occur in an N-input cross-bar network. Thus the circuit implementation of the butterfly network is more area-efficient than a standard cross-bar circuit. The butterfly circuit 210 of FIG. 2 has 8 log₂ 8=24 cross-points. At each of these 24 cross points, an input data element can either be passed straight through to the same position at the subsequent stage or can be swapped to the predetermined swap position in the subsequent stage. Accordingly, the main rearrangement circuitry comprises 24*(2:1) multiplexers. The supplementary rearrangement circuitry 250 requires a further 8*(2:1) multiplexers corresponding to the second row of circles in FIG. 2.

In the main rearrangement circuitry 210 of FIG. 2, since the circuitry is a butterfly network, there exists a unique path between a given input data element and a given output data element of the butterfly network. Thus, for example, consider an input data element 218 and an output data element 224. The only way of arriving at output element 224 starting from input element 218 is to configure the butterfly network to take the swap path 219 at the first stage of rearrangement 212, to take the swap path 221 to data element position 222 in the second rearrangement stage 214 and finally to take the pass-through path (not shown) between data element 222 and the final output data element 224. This is true for any given pair of input data elements and output data elements of the butterfly network 210.

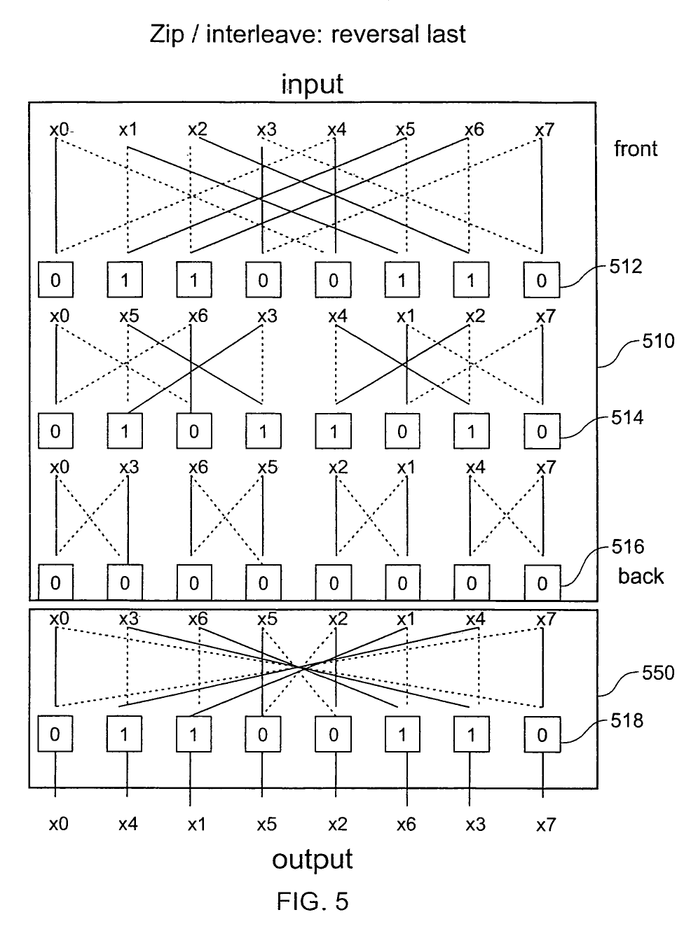

It can be seen that in each stage of the butterfly network N inputs are divided into N/2 pairs. Two inputs in a pair can go in the same position at the output (i.e. the pass through path) or can alternatively exchange position with the other one. This is determined by a single control bit. So N/2 control bits are required for N/2 data pairs at each stage of the butterfly network. The stages of the butterfly network are differentiated by how the data elements are paired. If we count the stages starting from zero, then the distance between two paired data elements in stage 1 is 2ⁱ Thus strictly speaking stage 0 of the butterfly network of FIG. 2 for which N=8 involves a distance of one between two paired bits, the stage 1 involves a distance of two between two paired data elements and stage 2 involves a distance of four between two paired data elements. Thus it can be seen that in the arrangement of FIG. 2 the back of the butterfly network receives the output from the supplementary rearrangement stage 250. In alternative arrangements, the main rearrangement circuitry 210 is placed prior to the supplementary rearrangement circuit 250 such that the main rearrangement circuitry 210 would be front to back instead of back to front and in this alternative arrangement the output of the butterfly network is supplied as input to the reversal stage 250. Such an embodiment is described below in relation to FIG. 5.

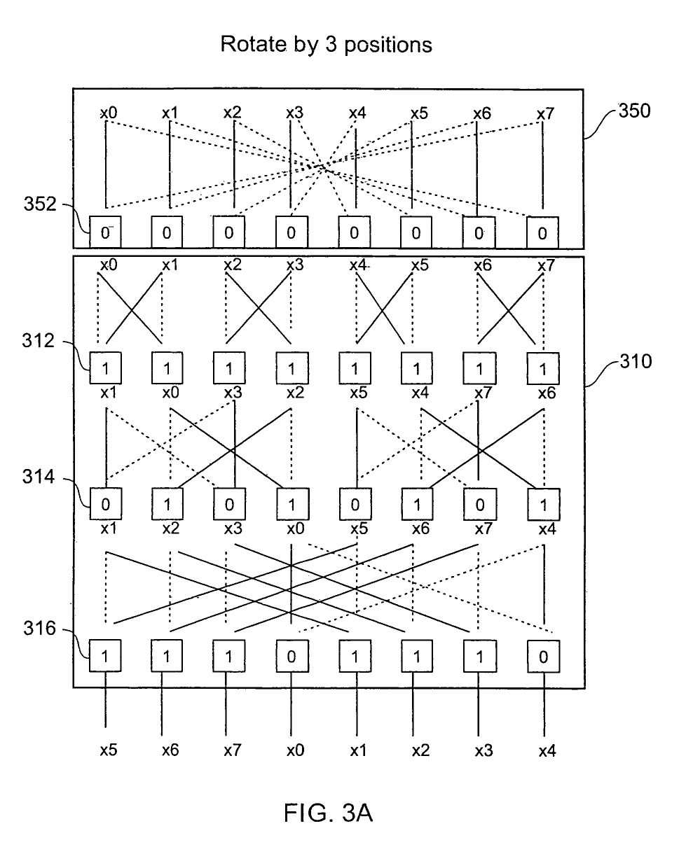

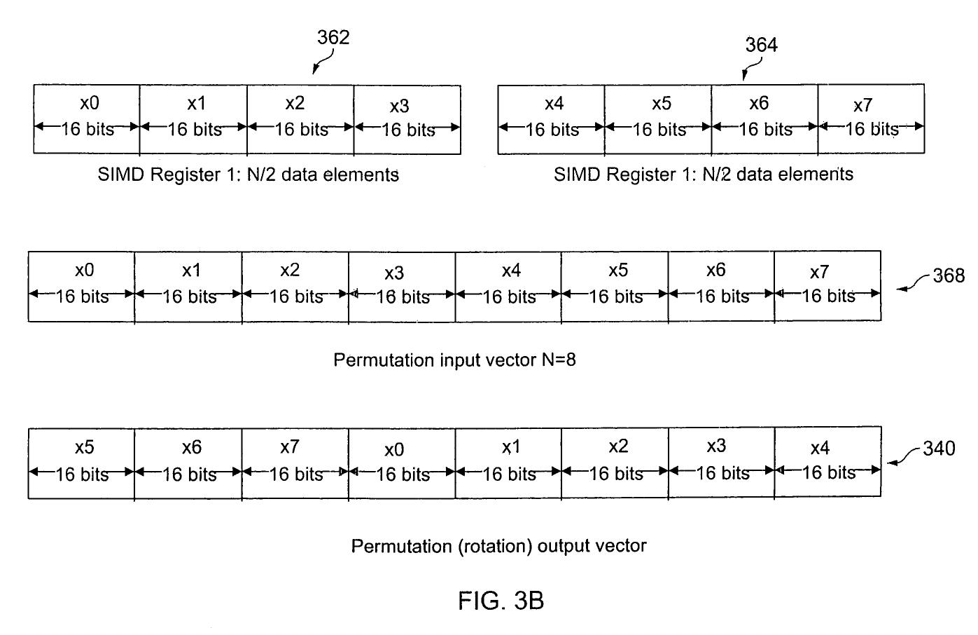

FIG. 3A schematically illustrates a configuration of the rearrangement circuitry 200 (see FIG. 2) for performing a rotation of a packed input vector of N=8 data elements by three positions. The rearrangement circuitry of FIG. 3 comprises main rearrangement circuitry 310 which performs rearrangement operations to the output data elements of the supplementary rearrangement circuitry 350. The main rearrangement circuitry 310 comprises a first row of eight multiplexers 312, a second row of eight multiplexers 314 and a third row of eight multiplexers 316. There is a row of multiplexers for each stage of the butterfly network. In addition there is a further row of 8 multiplexers 352 corresponding to the supplementary rearrangement circuitry 350.

In this description a control bit of “1” indicates swapping whereas a control bit of “0” indicates passing through for each a pair of data elements. It will be appreciated that in alternative arrangements a control bit of “0” could indicate swapping and a control bit of “1” could indicate passing through. In the embodiment of FIG. 3A the row of multiplexers 352 of the supplementary rearrangement circuitry 350 are all set to 0 so all of the data elements pass straight the circuit 350. The first set of multiplexers 312 of the first rearrangement stage of the main rearrangement circuitry 310 (butterfly network) are all set to 1 so that all of the data elements swap positions with their respective paired data elements. In the second stage of the butterfly network 310 the row of multiplexers 314 swaps data element pairs x0 and x2 and x4 and x6 but data elements x1, x3, x5 and x7 pass straight through this stage. Finally at the third stage of the butterfly network 310 the row of multiplexers 316 pass through data elements x0 and x4 but swap all of the other data element pairs: x1 and x5; x2 and x6; x3 and x7 as indicated by the control bits. Accordingly, it can be seen that the input vector of (x0, x1, x2, x3, x4, x5, x6, x7) is rotated by three data elements to form the output the vector (x5, x6, x7, x0, x1, x2, x3, x4).

FIG. 3B schematically illustrates how the input vector to the circuit of FIG. 3A is formed from a plurality of multi-bit data elements and shows the relationship between a packed input vector (N=8) and a packed output vector in which the input vector data elements have been rotated by three positions (as generated by the circuit of FIG. 3A). As shown in FIG. 3B, a permutation input vector 368 comprising a total of eight 16-bit data elements is formed from N/2 data elements 362 of a first SIMD register and a further N/2 data elements 364 of a second SIMD register. Note that in the embodiment of FIG. 1 N=64 and each of the two constituent groups of input data elements 362, 364 would thus comprise thirty-two rather than four data elements. In this case each thirty-two element input vector is read from a respective one of the SIMD registers 130 (see FIG. 1) and concatenated to form a sixty-four element input vector.

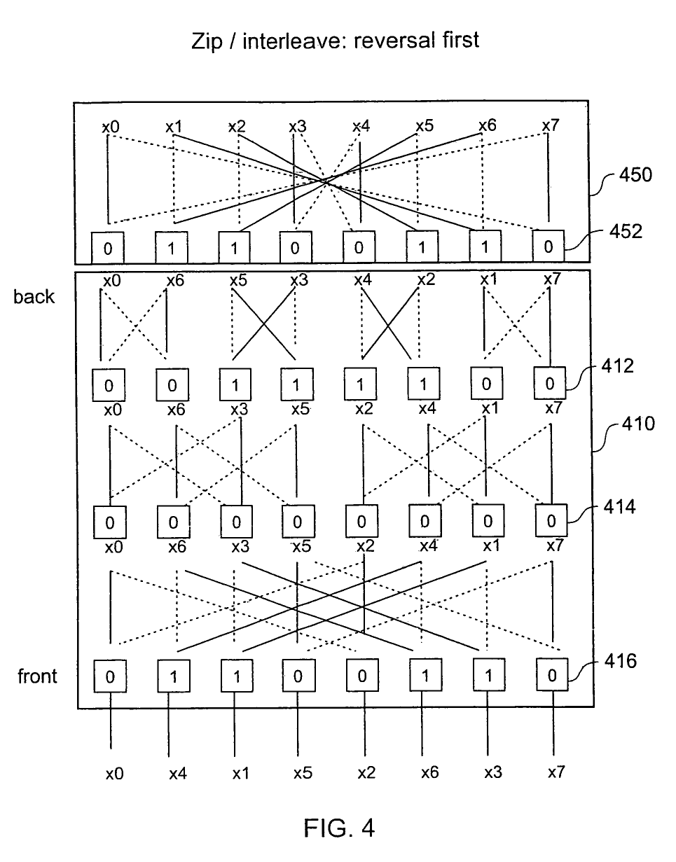

Thus it can be seen from FIG. 3B that the input vector comprises a packed vector of eight data elements according to an input ordering and the output of the rearrangement circuitry 310, 350 of FIG. 3A comprises a packed output vector 340 comprising the same eight data elements but permuted such that the output ordering is rotated by three positions to the right. Each of the circuits of the embodiments of FIGS. 4 to 7 described below operate on packed input vectors comprising multi-bit data elements and generate packed output vectors in a similar manner to that illustrated in FIG. 3B.

FIG. 4 schematically illustrates an embodiment of the rearrangement circuitry 120 of FIG. 1 configured to perform an interleave rearrangement operation. The rearrangement circuitry comprises main rearrangement circuitry 410 and supplementary rearrangement circuitry 450. As for the FIG. 3A embodiment, the main rearrangement circuitry 410 comprises a butterfly network whereas the supplementary rearrangement circuitry 450 comprises a reversal network. In this case, the reversal network 450 operates on the input data elements before those data elements are input to the butterfly data network and the back of the butterfly network receives the output of the reversal circuitry 450. As with previous examples N=8 for simplicity of illustration although it will be appreciated that any number of input data elements could be supplied to the rearrangement circuitry according to embodiments of the invention.

The supplementary rearrangement circuitry 450 is configured by the control bits of a first set of multiplexers 452, which are configured to swap the data element pair x1 and x6 and also to swap the data element pair x2 and x5, but to let data elements x0, x3, x4 and x7 pass straight through. The first set of multiplexers 412 of the main rearrangement circuitry 410 are configured to swap the data element pair x3 and x5 and also to swap the data element pair x2 and x4, but to let the other data element pairs (x0 and x6) and (x1 and x7) pass straight through. The second set of multiplexers 414 of the main rearrangement circuitry 410 is configured to let all eight data elements pass straight through from their previous output stage positions. Finally, the third set of multiplexers 416 of the butterfly network is configured to swap the data element pair x4 and x6 and also swap the data element pair x1 and x3 but to let data elements x0, x5, x2 and x7 pass straight through. Accordingly, it can be seen that the N/2 input vector (x0, x1, x2, x3) is interleaved with the second N/2 input vector (x4, x5, x6, x7) to generate the N=8 packed output vector (x0, x4, x1, x5, x2, x6, x3, x7). Thus the interleave rearrangement has been performed using a total of 32 (2:1) multiplexers. This compares with previously known systems that would require N*(N−1)=56 multiplexers for N=8 for a full cross-bar circuit arrangement; or a total of (2*log₂ (N)−1)*N=40 multiplexers for a full permutation network (e.g. comprising 2 back-to-back butterfly networks).

FIG. 5 schematically illustrates an embodiment of the rearrangement circuitry 120 of FIG. 1 configured to perform the same interleave operation as the rearrangement circuit of FIG. 4, but in which the main rearrangement circuitry is configured to perform a rearrangement prior to (before the data elements are supplied to) the supplementary rearrangement circuitry 550. In this embodiment, the main rearrangement circuitry 510 comprises an N=8 element butterfly network which is arranged front to back (rather than back to front as in the embodiments of FIGS. 3A and 4). The output of the back of the butterfly network 510 is supplied as input to an N=8 element reversal circuit 550 to form an output vector. The control bits of the four rows of multiplexers 512, 514, 516, 518 are set as shown. In particular, the first row of multiplexers 512 of the butterfly network 510 is configured to swap data element pair (x1 and x5) and also swap data element pair (x2 and x6) but to pass through data elements x0, x3, x4 and x7. The second row of multiplexers 504 of the butterfly network 510 is configured to swap the data element pair (x5 and x3) and the data element pair (x4 and x2) but to pass through data elements x0, x6, x1 and x7. The third row of multiplexers 516 of the butterfly network 510 is configured to pass through all eight data elements. The supplementary rearrangement circuitry 550 is configured to reverse the data elements pair (x3 and x4) and the pair (x1 and x6) but to pass through data elements x0, x5, x2 and x7. This achieves the same interleaved packed output vector, (x0, x4, x1, x5, x2, x6, x3, x7) as was output by the embodiment of FIG. 4 but using a different circuit configuration.

It will be appreciated that for the purpose of the interleave permutation, the middle row of multiplexers 414 of the butterfly network 410 of FIG. 4 and the last row of multiplexers 516 of the butterfly network 510 of FIG. 5 could be eliminated yet the interleave operation could still be effectively performed. However, inclusion of all four sets of multiplexers enables the rearrangement circuitry to be flexible enough to perform a plurality of different rearrangement operations in an efficient manner rather than being configured specifically (and inflexibly) to perform a single type of permutation. Yet, the rearrangement circuitry according to the present technique requires fewer multiplexers than the known full cross-bar circuitry or full permutation network formed by two back-to-back butterfly circuits.

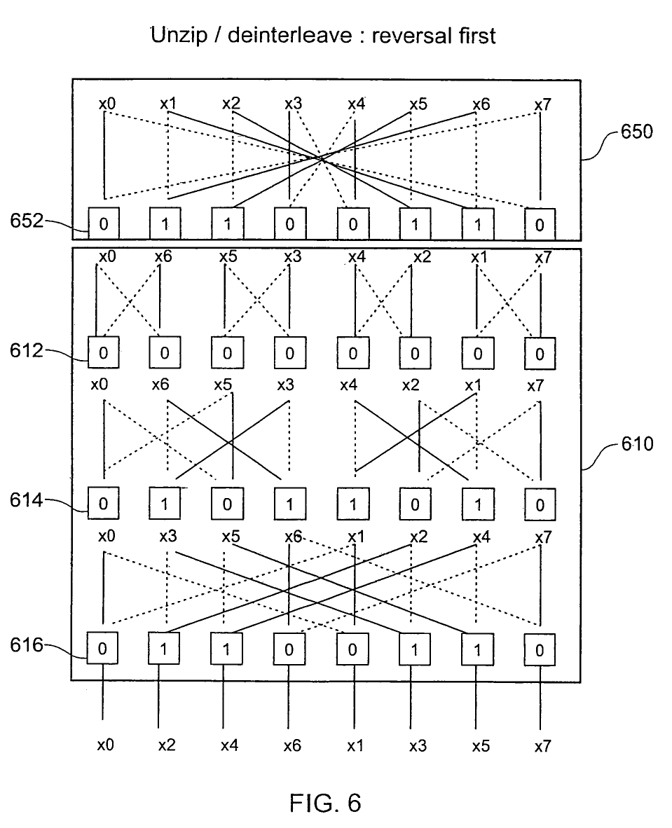

FIG. 6 schematically illustrates an embodiment of the rearrangement circuitry 120 of FIG. 1 configured to perform a de-interleave (unzip) permutation operation in which a single reversal stage is performed prior to a butterfly network permutation. The circuit comprises main rearrangement circuitry 610 and supplementary rearrangement circuitry 650. The supplementary rearrangement circuitry 650 performs an optional single-stage data reversal in which a set of 2:1 multiplexers 652 is configured to reverse a data element pair (x1 and x6) and also to reverse a data element pair x2 and x5, whilst data elements x0, x3, x4 and x7 pass straight through in their original positions, as input to the butterfly network 610. In the butterfly network 610 a first row of multiplexers 612 is configured to let all eight data elements pass straight through. A second row of multiplexers 614 is configured to swap the data element pair (x3 and x6) and the data element pair (x1 and x4) but to let data elements x0, x5, x2 and x7 pass straight through. The final row of multiplexers 616 of a butterfly network 610 is configured to swap the data element pair x2 and x3 and the data element pair x4 and x5, but to let the data elements x0, x6, x1 and x7 pass straight through. Accordingly, the packed eight element input vector (x0, x1, x2, x3, x4, x5, x6, x7) is de-interleaved to generate two output vectors of length N/2: (x0, x2, x4, x6) and (x1, x3, x5, x7).

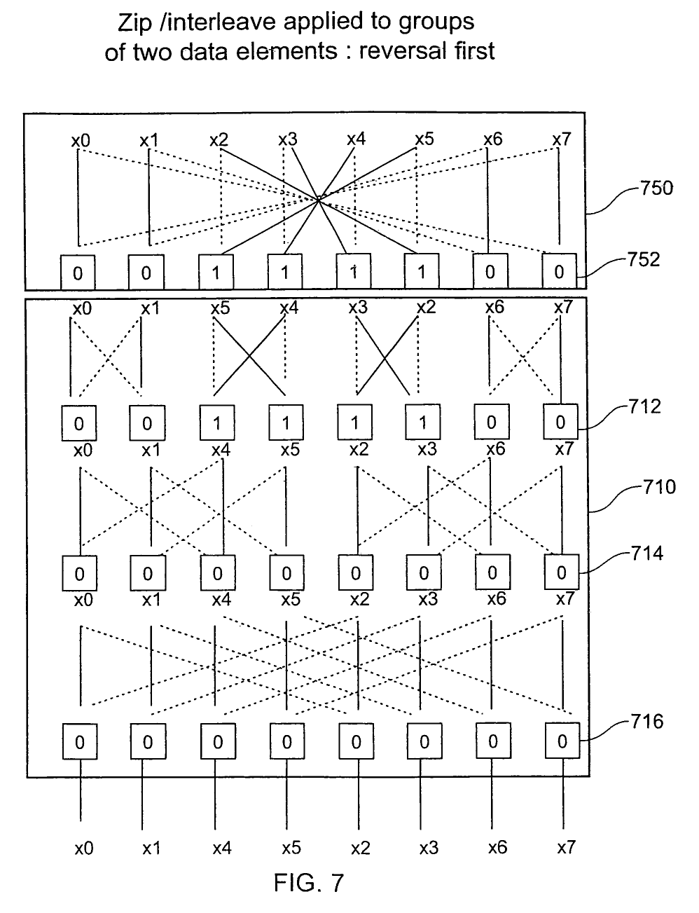

FIG. 7 schematically illustrates an embodiment of the rearrangement circuitry 120 of FIG. 1 configured to perform an interleave permutation which is applied to groups of two data elements. In this particular embodiment, a supplementary rearrangement circuit 750 performs an optional reversal operation on eight data elements prior to a butterfly network 710 representing main rearrangement circuitry performing three subsequent stages of rearrangement to the input data elements. Since the interleave is being applied to groups of two data elements rather than to individual data elements it can be seen that control bits in the row of multiplexers 752 associated with the supplementary rearrangement circuit 750 and the three rows of multiplexers 712, 714, 716 of the butterfly network 710 are grouped such that adjacent pairs of multiplexers have identical control bits. In order to perform de-interleave operation, the supplementary rearrangement circuit is configured such that the group of data elements (x4; x5) swaps positions with the group of data elements (x2; x3) in the reversal stage 750. The first set of multiplexers 712 of the butterfly network 710 is configured such that a data element pair x4 and x5 exchange positions and the data element pair (x2 and x3) exchange positions whilst the data elements x0, x1, x6 and x7 pass straight through. Note that although in the final output vector, data element groups (x0, x1), (x2, x3), (x4, 5×5) and (x6, x7) must remain as intact groups of ordered pairs, it can be seen that the output of the row of multiplexers 752 of the supplementary circuit 750 performs a reversal operation which permutes the ordering of the group (x4, x5) to (x5, x4) and likewise has permutes the ordering of the group (x2, x3) to the ordering (x3, x2). However, the appropriate ordering is recovered as a result of the control bit configuration of the first row of multiplexers 712 of the butterfly network 710. In fact the output of the first row of multiplexers 712 of the butterfly network 710 represents the desired interleaved output vector (x0, x1, x4, x5, x2, x3, x6, x7). Accordingly, the second and third rows of multiplexers 714, 716 of the butterfly network 710 have their control bits all set to 0 such that the data elements pass straight through to the output stage without further rearrangement. It will be appreciated that in the example of FIG. 7 groups of two data elements are used for the purposes of performing an interleave operation but in alternative arrangements each group could comprise a different number of constituent data elements depending on the total number of input data elements.

A computer program product storing a computer program may be provided to configure the main rearrangement circuitry and the supplementary rearrangement circuitry in the above described embodiments to perform the rearrangement operations.

In the embodiments described above the main rearrangement circuitry comprises a butterfly network whilst the supplementary rearrangement circuitry comprises a single rearrangement stage comprising an optional reversal operation. However alternative embodiments are possible comprising a main rearrangement circuit that is not a butterfly network but nevertheless has a first number of rearrangement stages in which there is a unique path between a given input element and a given output element and a supplementary rearrangement circuit comprising a number of rearrangement stages that is less than the number of stages of the main rearrangement circuitry. The supplementary rearrangement circuitry need not perform an optional reversal operation but could be configured to perform a different rearrangement operation to that illustrated in the above embodiments. The rearrangement circuitry according to the present technique is arranged to perform a set of permutations less than a full set of permutations but is still capable of performing a plurality of different permutation operations.

The embodiments described above include examples of interleaving, deinterleaving and rotation permutation operations. It will be appreciated that alternative permutations to these examples can also be performed according to the present technique. Other examples of permutations that can be performed by a data apparatus according to embodiments of the invention include reversal operations and transpose operations. Considering an eight element input vector [x0, x1, x2, x3, x4, x5, x6, x7], for the reversal permutation the output vector is [x7, x6, x5, x4, x3, x2, x1, x0]. Considering the same input vector [x0, x1, x2, x3, x4, x5, x6, x7], the transpose operation gives an output vector [x0, x4, x2, x6, x1, x5, x3, x7]. As for the previous example embodiments, each data element is a multi-bit data element.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. Apparatus for processing data comprising:
rearrangement circuitry having a plurality of rearrangement stages for rearranging a plurality N of input data elements, each rearrangement stage comprising at most N multiplexers arranged to select between M data elements, where M is an integer less than N;
control circuitry responsive to program instructions to control said rearrangement circuitry to perform rearrangement operations;
wherein said rearrangement circuitry comprises main rearrangement circuitry having a plurality of rearrangement stages in which there is a unique path between any given input element and any given output element and supplementary rearrangement circuitry in which from each input data element there is a path to at most C output data elements where 1<C<N/2, and wherein said rearrangement circuitry is configurable by said control circuitry to perform a plurality of different rearrangement operations.

2. Apparatus as claimed in claim 1, wherein C=2.

3. Apparatus as claimed in claim 1, wherein N≧8.

4. Apparatus as claimed in claim 1, wherein said supplementary rearrangement circuitry is arranged to perform an optional reversal operation.

5. Apparatus as claimed in claim 4, wherein said supplementary rearrangement circuitry is configured to receive a plurality of P input data elements and to optionally exchange an input data element i with an input data element P−1-i, where i is an integer in the range 0 to (P−1) and wherein P is equal to N.

6. Apparatus according to claim 4, wherein said reversal operation is performed on a full set comprising N data elements received by said supplementary rearrangement circuitry.

7. Apparatus as claimed in claim 1, wherein said main rearrangement circuit comprises a butterfly network.

8. Apparatus as claimed in claim 1, wherein M=2 such that each of said multiplexers is arranged to select between two data elements.

9. Apparatus according to claim 1, wherein said supplementary rearrangement circuitry is arranged to perform said supplementary rearrangement prior to said main rearrangement circuitry performing said main rearrangement.

10. Apparatus according to claim 1, wherein said supplementary rearrangement circuitry is arranged to perform said supplementary rearrangement after said main rearrangement circuitry has performed said main rearrangement.

11. Apparatus according to claim 1, wherein said rearrangement circuitry comprises a total of (log₂(N)+1)*N multiplexers.

12. Apparatus according to claim 1, wherein said main rearrangement circuitry comprises a total of log₂N stages.

13. Apparatus as claimed in claim 1, wherein at least one of said N input data elements is a multi-bit data element.

14. Apparatus as claimed in claim 1, wherein said apparatus comprises a register bank and wherein each of said plurality N of input data elements is read from said register bank.

15. Apparatus according to claim 14, wherein each register of said register bank is arranged to store a packed vector comprising a plurality of multi-bit data elements, each of said multi-bit data elements corresponding to a respective one of said plurality N of input data elements of said rearrangement circuitry.

16. Apparatus as claimed in claim 15, wherein said plurality N of input data elements of said rearrangement circuitry are read from a plurality Q of registers of said register bank.

17. Apparatus according to claim 1, wherein said control circuitry is responsive to a rotation program instruction to cause said rearrangement circuitry to perform a rotation operation on said plurality of N input data elements.

18. Apparatus according to claim 1, wherein said control circuitry is responsive to an interleave program instruction to cause said rearrangement circuitry to perform an interleave operation on said plurality of N input data elements.

19. Apparatus according to claim 1, wherein said control circuitry is responsive to a de-interleave program instruction to cause said rearrangement circuitry to perform a de-interleave operation on said plurality of N input data elements.

20. Apparatus according to claim 1, wherein said rearrangement circuitry is configurable to perform each of a rotation operation, an interleave operation and a de-interleave operation.

21. Apparatus according to claim 1, wherein said control circuitry is arranged to control said rearrangement circuitry to perform one or more of said rearrangement operations such that groups of two or more of said plurality N of input data elements are rearranged.

22. A virtual machine providing an emulation of an apparatus for processing data, said apparatus comprising:
rearrangement circuitry having a plurality of rearrangement stages for rearranging a plurality N of input data elements where N is an integer greater than or equal to two, each rearrangement stage comprising at most N multiplexers arranged to select between M data elements, where M is an integer less than N;
control circuitry responsive to program instructions to control said rearrangement circuitry to perform rearrangement operations;
wherein said rearrangement circuitry comprises a main rearrangement circuitry having a plurality of rearrangement stages in which there is a unique path between any given input element and any given output element and a supplementary rearrangement circuitry in which from each input data element there is a path to at most C output data elements where 1<C<N/2 and wherein said rearrangement circuitry is configurable by said control circuitry to perform a plurality of different rearrangement operations.

23. A method of performing rearrangement operations on data on a data processing apparatus having rearrangement circuitry consisting of main rearrangement circuitry and supplementary rearrangement circuitry, said rearrangement circuitry having a plurality of rearrangement stages for rearranging a plurality N of input data elements, each rearrangement stage comprising at most N multiplexers arranged to select between M data elements, where M is an integer less than N and having control circuitry responsive to program instructions to control said rearrangement circuitry to perform rearrangement operations, said method comprising:
using said main rearrangement circuitry having a plurality of rearrangement stages in which there is a unique path between any given input element and any given output element to perform a main set of rearrangement operations on at least a subset of said plurality N of input data elements;
using said supplementary rearrangement circuitry in which from each input data element there is a path to at most C output data elements where 1<C<N/2 to perform a supplementary set of rearrangement operations on at least a subset of said plurality N of input data elements; and
using said control circuitry to configure said main rearrangement circuitry and said supplementary rearrangement circuitry to perform said main set of rearrangement operations and said supplementary set of rearrangement operations respectively.

24. Method as claimed in claim 23, wherein said supplementary set of rearrangement operations is performed after said main set of rearrangement operations.

25. Method as claimed in claim 23, wherein said supplementary set of rearrangement operations is performed before said main set of rearrangement operations.

26. A computer program product comprising a computer program for controlling a computer to perform the method as claimed in claim 23.

27. Apparatus for processing data comprising:
means for performing data rearrangements having a plurality of rearrangement stages for rearranging a plurality N of input data elements, each rearrangement stage comprising at most N multiplexers arranged to select between M data elements, where M is an integer less than N;
means for controlling responsive to program instructions to control said means for performing data rearrangements to perform rearrangement operations;
wherein said means for performing data rearrangements comprises means for performing main rearrangements having a plurality of rearrangement stages in which there is a unique path between any given input element and any given output element and means for performing supplementary rearrangements in which from each input data element there is a path to at most C output data elements where 1<C<N/2 and wherein said means for performing data rearrangements is configurable by said means for controlling to perform a plurality of different rearrangement operations.
